(19) United States
(12) Patent Application Publication
(10) Pub. No.: US 2025/0010933 A1
(43) Pub. Date: Jan. 9, 2025

(54) Seat Assembly for a Tilting Vehicle

(71) Applicant: Bayerische Motoren Werke Aktiengesellschaft, Muenchen (DE)

(72) Inventors: Christian ISING, Muenchen (DE); Dieter STRASSER, Oberhausen (DE)

(21) Appl. No.: 18/711,684

(22) PCT Filed: Jan. 13, 2023
(86) PCT No.: PCT/EP2023/050744

§ 371 Date: May 20, 2024

(30) Foreign Application Priority Data
Jan. 27, 2022 (DE) 10-2022 101 855.5

(51) Int. Cl. B62J 1/12; B62J 1/14; B62J 9/14

(52) U.S. Cl. CPC B62J 1/12; B62J 1/14; B62J 9/14

(57) ABSTRACT

A seat assembly for a tilting vehicle includes at least a seat bench which has a first seat region in which a rider can be located for riding and operating the tilting vehicle, and which has at least a second seat region in which a passenger, such as a pillion passenger, can be located, and includes a receiving unit which has at least two opposing wall elements which are movable from a seat position in which at least one of the at least two wall elements forms a seat base, extending in a seat plane, of the second seat region of the seat bench, into a receptacle position in which the at least two wall elements, extending substantially transversely or obliquely in relation to the seat plane and mutually contactlessly spaced, delimit a receiving region on at least two sides, in which receiving region at least one object can be disposed. The passenger can be located on the seat base, directly in contact therewith.

### BACKGROUND AND SUMMARY

The invention relates to a seat assembly for a tilting vehicle.

In tilting vehicles, the seat assemblies often comprise simple benches, in other words benches in which a rider of the tilting vehicle and, optionally, a passenger, also referred to as a pillion passenger, can be located on the bench. Furthermore, seat assemblies are known in the art, in which the bench has a seat area for a rider of the tilting vehicle and another area of the bench is designed purely as a luggage carrier. In addition, benches are known in the art, in which a luggage carrier designed as a separate component can be mounted on the bench as required.

In the seat assemblies known in the art, it has proved disadvantageous that either the bench as a whole has to be replaced, for example, when switching from a two-seater option to an option with a luggage carrier portion, or that an additional luggage carrier has to be mounted on the seat assembly and dismounted again, which is awkward.

An object of an exemplary embodiment of the invention is to propose a seat assembly for a tilting vehicle, in which the transition from carrying a passenger to transporting objects, and vice versa, is simplified.

This object is achieved by a seat assembly for a tilting vehicle comprising at least one bench, which includes a first seat area on which a rider can be located for riding and operating the tilting vehicle, and at least one second seat area in which a passenger, such as a pillion passenger, can be located, and at least one receiving unit which comprises at least two mutually opposing wall elements which can be moved from a seat position in which at least one of the at least two wall elements forms a seat surface, extending in a seat plane, of the second seat area of the bench, wherein the passenger can be located on the seat surface, directly in contact therewith, can be moved into a receiving position in which the at least two wall elements, extending substantially transversely or obliquely to the seat plane and spaced apart from one another in a contactless manner, define a receiving area on at least two sides, in which receiving area at least one object can be disposed.

Because the seat assembly comprises a bench which, in addition to a first seat area in which a rider can be located to operate the tilting vehicle, also comprises a second seat area in which a passenger can be located in the seat position and in which an object can be arranged in the receiving position and held by the at least two wall elements, the transition from transporting people to transporting objects can easily be made without having to replace the bench.

Because the at least two wall elements in the receiving position define a receiving area on two sides, the receiving area can be accessible from two additional sides and from above. This means that objects can also be arranged and held in the receiving area, which objects are larger due to their size and extent than the receiving area that has been made available and project beyond it.

A tilting vehicle is understood to include bicycles, motorcycles or motor vehicles similar to motorcycles, such as motor scooters, in particular two, three or four-wheeled motor scooters, scooters, tilting trikes, quadbikes or the like.

In order to provide seat comfort in the second seat area, it has proved advantageous for at least one of the at least two wall elements to comprise a cushion body on a side facing the passenger in the seat position and/or a particularly hard-shell, planar body on a side facing the receiving area in the receiving position, to which the cushion body is attached.

Because at least one of the at least two wall elements comprises a cushion body on one side facing the passenger in the seat position, seat comfort of the bench in the second seat area can be enhanced.

The fact that at least one of the at least two wall elements comprises a hard-shell, planar body on the side facing away from the cushion body means that forces, for example the weight force of the passenger, can be absorbed by the wall element in the seat position and transferred to the bench.

Moreover, embodiments of the seat assembly are conceivable in which at least two of the at least two wall elements are arranged overlapping one another in the seat position or in which at least two of the at least two wall elements abut one another with their end faces extending transversely to the seat plane in the seat position, continuing with each other and together forming the seat surface of the second seat area.

When at least two of the at least two wall elements are arranged overlapping one another in the seat position, the wall element that is closest to the passenger and encompasses the seat surface of the second seat area can include the cushion body and the hard-shell, planar body. The other wall element, which is arranged below the wall element encompassing the cushion body in the seat position, may be formed exclusively from a hard-shell, planar body in such a case. Furthermore, in that case, the other wall element may also include a cushion body in one embodiment.

When at least two of the at least two wall elements abut one another with their end faces extending transversely to the seat plane in the seat position, continue with each another and together form the seat surface of the second seat area, both wall elements include a cushion body on the side facing the passenger in the seat position and a hard-shell, planar body on the side facing away from the cushion body.

In principle, it is contemplated that an object in the receiving area is solely limited in its movement by the two wall elements. In this case, a basket-like or box-like container can be arranged or clamped between the wall elements or slid onto the wall elements with a receiving area, thereby being held by the wall elements.

Furthermore, in a development of the seat assembly it is provided that the receiving unit comprises at least two transverse walls extending transversely to the at least two wall elements, which transverse walls are arranged parallel to the at least one wall element forming the seat surface in the seat position and are arranged transversely or diagonally to the seat plane and transversely to the wall element in the receiving position and along with the wall elements enclose the receiving area entirely in a frame-like manner and/or that the receiving unit comprises a recess in the bench below the second seat area of the bench, in which at least one of the at least two wall elements and/or at least one of the at least two transverse walls is arranged in the seat position.

The fact that the receiving unit comprises at least two transverse walls extending transversely to the at least two wall elements means that the receiving area is entirely enclosed by the wall elements and the transverse walls in a frame-like manner and accessible from above. In this case, the wall elements and the transverse walls together form a basket-like container.

Because the bench includes a recess in the area of the second seat area, in which at least one of the at least two wall elements and/or at least one of the at least two transverse walls is arranged in the seat position, the receiving unit can be compactly accommodated in the bench, in particular when the first seat area and the second seat area are in one and the same seat plane. Furthermore, the recess in the bench in the receiving position can expand the receiving area.

In order to fix the transverse walls and the wall elements in place, at least in the receiving position, it has proved advantageous for the receiving unit to comprise at least one fixing unit, by means of which the transverse walls and the wall elements can be detachably fixed to one another, in particular clipped to one another, at least in the receiving position.

In a development, it has proved advantageous for the wall elements and the transverse walls to be flush with one another on the same plane in the receiving position on the side facing away from the seat plane, in particular without steps and offsets.

Furthermore, it has proved advantageous for the wall elements in the receiving position to extend substantially parallel or diagonally to a plane spanned by the vertical axis and longitudinal axis of the tilting vehicle and/or for the transverse walls in the receiving position to extend substantially parallel or diagonally to a plane spanned by the vertical axis and transverse axis of the tilting vehicle.

If the two wall elements in the receiving position extend substantially parallel or diagonally to a plane spanned by the vertical axis and longitudinal axis of the tilting vehicle, one extends where necessary between the end faces of the two wall elements in the seat position parallel to the direction of travel and centrally in the bench. This means that any forces exerted by a passenger on the second seat area can be evenly distributed across the two wall elements.

If the two transverse walls in the receiving position extend substantially parallel or diagonally to a plane spanned by the vertical axis and transverse axis of the tilting vehicle, they can be arranged spaced apart from one another in a contactless manner in the seat position.

The wall elements and the transverse walls can in principle be moved at random from the seat position to the receiving position, and vice versa. For example, it is conceivable for the transverse walls to be moved from the seat position into the receiving position by means of a translational movement. In one embodiment of the seat assembly, it has proved advantageous for at least one of the at least two wall elements and/or at least one of the at least two transverse walls to be movable from the seat position into the receiving position by means of rotation and detachably fixed therein against movement by means of a fixing means.

In this case, the wall elements can be rotated open about a pivot axis when moved from the seat position into the receiving position. In this case, a pivot axis of the transverse walls can run parallel to a transverse axis of the tilting vehicle and a pivot axis of the wall elements can run parallel to the longitudinal axis of the tilting vehicle.

In order to arrange the transverse walls and the wall elements in the seat position, the transverse walls are initially rotated from the receiving position into the seat position in this case and arranged in the recess in the bench. Subsequent to this, the wall elements are moved from the receiving position into the seat position in the manner of a swing door, where they form the seat surface of the second seat area.

In principle, it is contemplated for the receiving unit to be accessible from the outside from a side facing away from the seat plane. However, in order to at least partially shield the receiving area from environmental influences such as dirt and moisture, it has proved advantageous for the receiving unit to comprise at least one cover element that is movably fixed to a wall element or a transverse wall and can be moved from a storage position, in which the cover element is arranged parallel to and alongside the wall element or transverse wall, to a covering position in which the cover element extends parallel or diagonally to the seat plane and transversely or diagonally to the wall element or transverse wall and covers the receiving area against access from outside entirely or at least partially.

By movably fixing the cover element to a wall element or a transverse wall, the cover element is held securely against loss and can be stored in the seat position and moved from the storage position into the covering position in the receiving position.

In a development of the aforementioned embodiment, it has proved advantageous for the cover element to be foldable in the storage position, at least partially flexibly bendable and/or capable of being wound onto a drum body.

In this case, the cover element can, for example, comprise a textile, flexibly stretchable fabric or a rigid body movable, in particular foldable, about one or multiple axes.

Further features, details and advantages of the invention will become apparent from the attached claims, the drawings and the following description of two preferred embodiments of the seat assembly.

### BRIEF DESCRIPTION OF THE DRAWINGS

FIG. 1 is a plan view of a first exemplary embodiment of the seat assembly with a receiving unit in the seat position;

FIG. 2 is a plan view of the exemplary embodiment according to FIG. 1 with the receiving unit in the receiving position;

FIG. 3 is a sectional view through a second seat area of the bench in a second exemplary embodiment of the seat assembly with the receiving unit in the seat position;

FIG. 4 is a sectional view of the exemplary embodiment according to FIG. 3 with the receiving unit in the receiving position;

FIG. 5 is a sectional view of the exemplary embodiment according to FIGS. 3 and 4 in the receiving position of the receiving unit and with a cover element, in the covering position.

### DETAILED DESCRIPTION OF THE DRAWINGS

The figures depict two exemplary embodiments of a seat assembly, generally denoted by reference sign 2, for a tilting vehicle (not explicitly shown in the figures). The seat assembly 2 comprises a bench 4, which includes a first seat area 6 where a rider can be positioned to operate the tilting vehicle. In addition, the bench 4 comprises a second seat area 8 where a passenger, such as a pillion passenger, can be positioned.

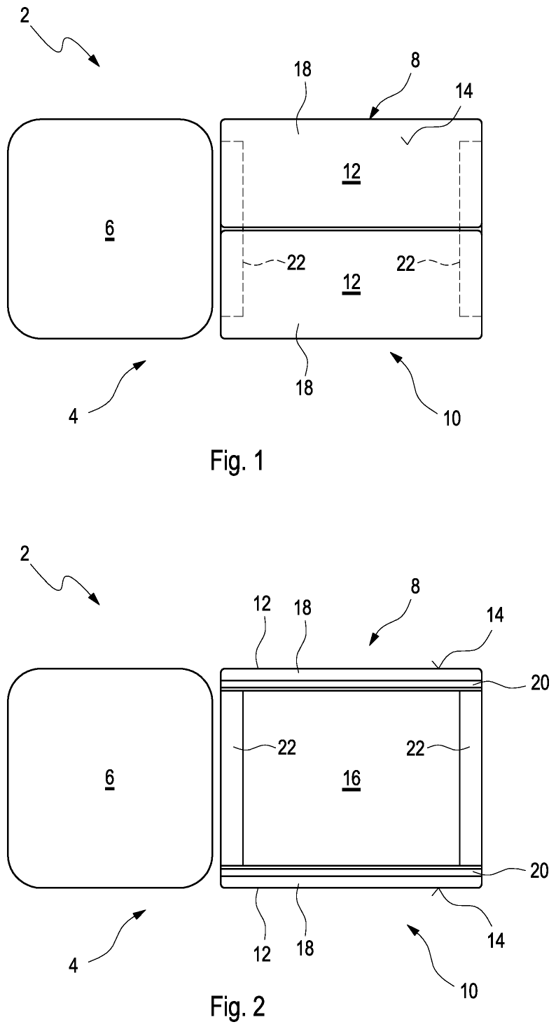

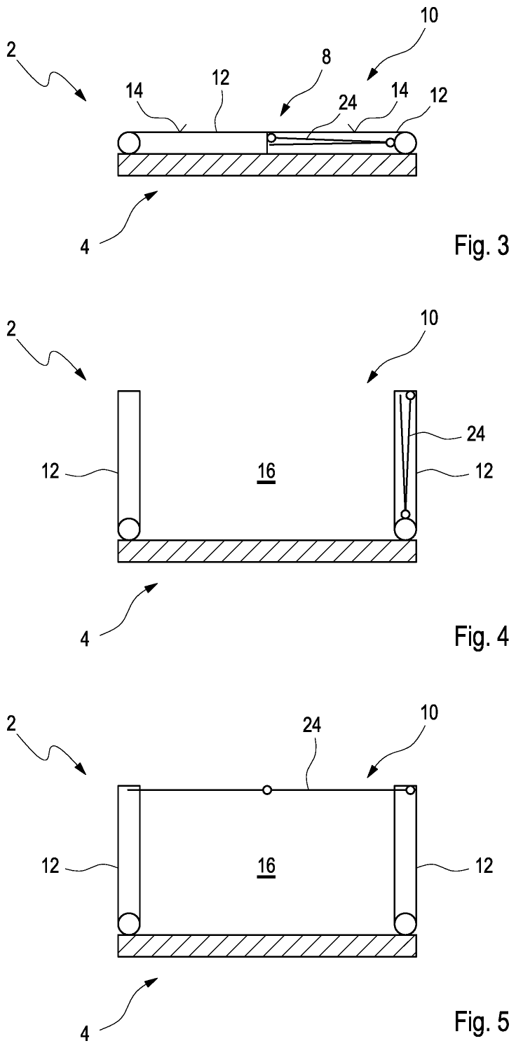

Furthermore, the seat assembly 2 comprises a receiving unit 10 which, in the exemplary embodiments shown in the figures, comprises two mutually opposing wall elements 12 which can be moved from a seat position (FIGS. 1 and 3) in which at least one of the at least two wall elements 12 forms a seat surface 14, extending in a seat plane, of the second seat area 8 of the bench, wherein the passenger can be located on the seat surface 14, directly in contact therewith, can be moved into a receiving position (FIGS. 2, 4 and 5) in which the two wall elements 12, extending substantially transversely or diagonally to the seat plane and spaced apart from one another in a contactless manner, define a receiving area 16 on the sides, in which receiving area at least one object can be disposed.

The wall elements 12 comprise a cushion body 18 on one side facing the passenger in the seat position and a planar body 20 on one side facing the receiving area 16 in the receiving position with the cushion body 18 being attached to the planar body 20. In the exemplary embodiments shown in the figures, the two wall elements 12 are configured in such a manner as to abut one another with their end faces extending transversely to the seat plane in the seat position, continuing with each other and together forming the seat surface 14 of the second seat area 8.

Furthermore, the receiving unit 10 comprises two transverse walls 22 which in the seat position are arranged parallel to the wall elements 12 forming the seat surface 14 in a recess of the bench 4, and in the receiving position are arranged transversely to the seat plane and transversely to the wall elements 12.

FIGS. 1 and 2 show a first exemplary embodiment of the seat assembly 2, in which the receiving area 16 is accessible from the outside.

The wall elements 12 and the transverse walls 22 enclose the receiving area 16 in a frame-like manner.

FIGS. 3 to 5 show a second exemplary embodiment of the seat assembly 2. In this embodiment, a cover element 24 is provided, which can be moved from a storage position (FIGS. 3 and 4), in which the cover element 24 is fixed to one of the two wall elements 12, into a covering position (FIG. 5), in which the cover element 24 extends parallel or diagonally to the seat plane and transversely or diagonally to the wall element 12 and covers the receiving area 16 against access from outside entirely or at least partially. The cover element 24 is foldable about a hinge.

The features of the invention disclosed in the foregoing description, in the claims and in the drawings can be essential, both individually and in any combination, in the implementation of the invention in its various embodiments.

### LIST OF REFERENCE SIGNS

2 seat assembly
4 bench
6 first seat area
8 second seat area
10 receiving unit
12 wall element
14 seat surface
16 receiving area
18 cushion body
20 body
22 transverse wall
24 cover element

1.-10. (canceled)

11. A seat assembly for a tilting vehicle, comprising:
at least one bench comprising a first seat area on which a rider is locatable for riding and operating the tilting vehicle and at least one second seat area in which a passenger is locatable; and
at least one receiving unit comprising at least two mutually opposing wall elements which are movable from a seat position in which at least one of the at least two wall elements forms a seat surface, extending in a seat plane, of the second seat area of the bench, wherein the passenger is locatable on the seat surface, directly in contact therewith, into a receiving position in which the at least two wall elements, extending substantially transversely or obliquely to the seat plane and spaced apart from one another in a contactless manner, define a receiving area on at least two sides, in which receiving area at least one object is disposable.

12. The seat assembly according to claim 11, wherein
at least one of the at least two wall elements comprises a cushion body on a side facing the passenger in the seat position, and/or comprises a hard-shell planar body on a side facing the receiving area in the receiving position, to which the cushion body is attached.

13. The seat assembly according to claim 11, wherein
at least two of the at least two wall elements are arranged overlapping one another in the seat position, or
at least two of the at least two wall elements abut one another with their end faces extending transversely to the seat plane in the seat position, continuing with each other and together forming the seat surface of the second seat area.

14. The seat assembly according to claim 11, wherein
the receiving unit further comprises at least two transverse walls extending transversely to the at least two wall elements, which transverse walls are arranged parallel to the at least one wall element forming the seat surface in the seat position and are arranged transversely or diagonally to the seat plane and transversely to the wall element in the receiving position and, along with the wall elements, enclose the receiving area entirely in a framed manner, and/or
the receiving unit further comprises a recess in the bench below the second seat area of the bench, in which recess at least one of the at least two wall elements and/or at least one of the at least two transverse walls is arranged in the seat position.

15. The seat assembly according to claim 14, wherein
the receiving unit further comprises at least one fixing unit, by which the transverse walls and the wall elements are detachably fixable to one another at least in the receiving position.

16. The seat assembly according to claim 14, wherein
the wall elements and the transverse walls are flush with one another on the same plane in the receiving position on the side facing away from the seat plane.

17. The seat assembly according to claim 14, wherein
the wall elements in the receiving position extend substantially parallel or diagonally to a plane spanned by vertical and longitudinal axes of the tilting vehicle, and/or
the transverse walls in the receiving position extend substantially parallel or diagonally to a plane spanned by the vertical axis and transverse axis of the tilting vehicle.

18. The seat assembly according to claim 14, wherein
at least one of the at least two wall elements and/or at least one of the at least two transverse walls are rotatably movable from the seat position into the receiving position and are detachably fixed therein against movement via a fixing device.

19. The seat assembly according to claim 11, wherein
the receiving unit further comprises a cover that is movably fixed to a wall element or a transverse wall and is movable from a storage position, in which the cover is arranged parallel to and alongside the wall element or transverse wall, to a covering position in which the cover extends parallel or diagonally to the seat plane and transversely or diagonally to the wall element or transverse wall and covers the receiving area against access from outside entirely or at least partially.

20. The seat assembly according to claim 19, wherein
the cover is foldable in the storage position, at least partially flexibly bendable and/or capable of being wound onto a drum body.
